(19) United States
(12) Patent Application Publication
(10) Pub. No.: US 2018/0297352 A1
(43) Pub. Date: Oct. 18, 2018

(54) THREE-DIMENSIONAL FROSTING TOUCH PATTERN LABEL FILM AND MANUFACTURING METHOD THEREOF

(71) Applicant: TZU-CHIN HUNG, TAIPEI CITY (TW)

(72) Inventor: TZU-CHIN HUNG, TAIPEI CITY (TW)

(21) Appl. No.: 15/595,180

(22) Filed: May 15, 2017

(30) Foreign Application Priority Data
Apr. 12, 2017 (TW) 106112266

(51) Int. Cl. B41F 17/00; C09D 11/107; C09D 11/03; C09D 11/033; C08J 7/04; G09F 3/02; G09F 3/00

(52) U.S. Cl. CPC B41F 17/006; C09D 11/107; C09D 11/03; C09D 11/033; C08J 7/047; G09F 2003/0208; G09F 3/0291; C08J 2300/00; C08J 2433/12; G09F 2003/0251; G09F 2003/0273; G09F 3/02

(57) ABSTRACT

Disclosed are a three-dimensional frosting touch pattern label film and a manufacturing method thereof, in which a printing ink including a composition including acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10% mixed together and containing a plurality of particles is used in gravure printing to print and combine a display pattern including at least one of a pattern, a character, and a mark on a surface of a single-layered label film substrate to form at least one three-dimensional pattern layer having a height of 0.05-0.1 mm, followed by slitting, adhering, and cutting and trimming to form a label film showing three-dimensional particle, frosting visual perception, and sanding touch.

### BACKGROUND OF THE INVENTION

### 1. Field of the Invention

The present invention relates to a label film that is applicable to thermal shrinkage, and more particularly to a label film that comprises a pattern, which contains three-dimensional particles and shows frosting visual perception and sanding touch, printed on a surface of a single-layered label film with a printing ink that contains therein three-dimensional particles to provide three-dimensional perception and frosting touch after thermal shrinkage, and a manufacturing method thereof.

### 2. The Related Arts

Thermal shrinkage label films have been widely used in applications of thermal shrinkage packages, particularly outer packages for liquid containers, such as bottles, kettles, and jars, in which beverages are received and held. With an increasingly severe demand for product package quality, three-dimensional outside visual perception, and surface touch of these containers, such as bottles, kettles, and jars, by the general consumers, the two-dimensional label films that include printings that are generally boring, visually monotonous, and showing no surface touch no long suit the needs of the consumers for high-quality package exhibiting three-dimensional, raised and recessed, patterns, frosting visual perception, and sanding touch for the container products such as bottles, kettles, and jars. Thus, physical treatment of frosting processing or sanding processing must be conducted on the liquid containers, such as bottles, kettles, and jars that are made of glass or ceramics, in order to achieve such an effect. This is generally time consuming and labor consuming and prevents mass production, making it adverse to economic performance of the related industry. In addition, this solution is only applicable to liquid containers, such as bottles, kettles, or jars that are made of glass or ceramics. Thus, the application of this solution is limited and cannot be used in plastic containers that are made of a non-glass or non-ceramic material.

Considering the need of a conventional label package film to show a high-end package quality exhibiting a three-dimensional, raised and recessed, pattern, frosting visual perception, and sanding touch in packing a container product, such as a bottle, a kettle, or a jar, it requires a wide operation temperature range of a high temperature range (90-150° C.) or a middle-high temperature range (50-150° C.) for a thermal shrinkage process in order to have the label film thermally shrunk on and wrapped around the outside of an object. Thus, the known solutions that either involve a thickness-increased printing ink film or adhesively attach a three-dimensional pattern sheet on a surface of a label film after thermal shrinkage operations fail to provide a high-end package quality exhibiting a three-dimensional, raised and recessed, pattern, frosting visual perception, and sanding touch, and are time-consuming, labor-consuming and expensive solutions, making them not economically effective and providing no industrial value, and do not provide an industrial effect in producing a large quantity of products. Further, the thickness-increased ink printing or the adhesively attached three-dimensional pattern sheet may readily get detached due to impact and abrasion occurring on a surface of the package.

Patent documents of prior art are known. An example includes U.S. Pat. No. 6,608, 121, which discloses a water-soluble resin composition and a water soluble film, proposing, in 2.5 mol % PVA (Polyvinyl Alcohol) of 100 parts by weight, addition of 20 parts by weight of oxidized cornstarch as a starch species, 10 parts by weight of silica having a particle size of 3 μm as an inorganic filler, and 900 parts by weight of water, followed by stirring at 90° C. to form an aqueous solution having a PVA concentration of 10%. The aqueous solution, after thoroughly deformed at 80° C., is cast onto a surface-matted polyester film and dried at 90° C. to form a matte film having a thickness of 40 micrometers and irregularities on one side.

The US patent is concerned about a water soluble film, which is not applicable to thermal shrinkage that is carried out at a middle or high temperature ranges and thus, the application is limited. Further the PVA material must be first subjected to hydrolysis. For example, it is recited in lines 18-22 of page 16 of the disclosure of the US patent that “[t]he gel formed was ground and allowed to stand at 60° C. for 5 hours to drive the hydrolysis to completion, followed by 3 days of Soxhlet washing with methanol and further followed by 3 days of driving at 80° C. under reduced pressure to give purified PVA.” In other words, an advance operation of hydrolysis must be conducted beforehand for the PVA material and this is limited to just the specific, single PVA material, and is not applicable to other plastic materials, such as polyvinyl chloride (PVA), oriented polystyrene (OPS), polyethylene terephthalate glycol-modified (PETG), polylactic acid (PLA), biaxially oriented polypropylene (BOPP), polyolefin (POF), casting polypropylene (CPP), oriented polypropylene (OPP) so that the economic value is limited. In addition, the US patent cannot provide a three-dimensional pattern on a plastic film and does not show frosting perception and sanding touch, making it inferior in regard of appearance and quality of product package made of plastic package films.

Further, Japan Patent Laid-Open Publication No. JP 2004-302125 discloses a foamed heat shrinkable label film and a foaming method thereof, in which a multi-layered foamed film structure is suggested to use in combination with gravure printing to form a three-dimensional pattern on the heat shrinkable film; however, the manufacturing process is complicated and requires a large amount of work hours and labor, making it expensive, and in addition, the heat-shrinkable film must be operated in a heat shrinkage operation environment formed in a specific steam channel having a relatively low temperature of 75-90° C. If the temperature exceeds 90° C., a foaming ink layer (12) may readily peel off a label substrate (11) and no sufficient wear resistance can be ensured. For a heat shrinkage operation temperature lower than 75° C., the foamability of the foaming ink layer (12) deteriorates, making it not possible to obtain desired tactile impression, meaning the foamed condition of the three-dimensional pattern cannot be effectively controlled so as not to provide an excellent and persistent three-dimensional pattern and surface sanding touch, thereby imposing undesired constraints to industrial applications of the three-dimensional patterned heat shrinkable film product. In addition, for applications to thermal shrinkage package for container products, such as bottles, kettles, and jars, it is not possible to show frosting visual perception and sanding touch.

In addition, Taiwan Patent Gazette Publication No. 1514339 discloses a three-dimensional pattern label film and a manufacturing method thereof, in which a better form of foamed three-dimensional pattern label film and a manufacturing method thereof are proposed; however, no disclosure is made concerning formation of three-dimensional pattern of ink printing on the thermal shrinkage film, and frosting visual perception and sanding touch.

### SUMMARY OF THE INVENTION

The primary object of the present invention is to provide a three-dimensional frosting touch pattern label film and a manufacturing method thereof that overcome the problems that a conventional liquid-holding container, such as a bottle, a jar, and a kettle, which is made of glass or ceramics must be processed with a time-consuming and labor-consuming polishing or sanding operation and the conventional thermal shrinkage label film does not allow for simultaneously exhibiting three-dimensional patterns, frosting vision, and sanding touch on a surface of the conventional thermal shrinkage label film by means of the known thermal shrinkage conditions, or must be carried out with foaming processing and under severe and specific thermal shrinkage operation conditions.

Thus, the three-dimensional frosting touch pattern label film according to the present invention comprises:

a single-layered label film substrate; and

at least a three-dimensional pattern layer, which comprises acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10%, which are mixed to form a printing ink containing a plurality of particles, and subjected to a step of gravure printing to have a display pattern comprising at least one of a pattern, a character, and a mark printed on and combined with a surface of the single-layered label film substrate such that the display pattern on the surface of the single-layered label film substrate forms at least one three-dimensional pattern layer having a height of 0.05-0.1 mm and providing three-dimensional particle frosting visual perception and sanding touch.

In the above three-dimensional frosting touch pattern label film, the single-layered label film substrate is formed of a single layer of a film material comprising one of PVC, OPS, PET-G, PLA, BOPP, POF, CPP, and OPP.

In the above three-dimensional frosting touch pattern label film, the particle-hand-feeling additive of the printing ink that comprises the plurality of three-dimensional particles in the three-dimensional pattern layer is formed of a material comprising methyl methacrylate resin.

In the above three-dimensional frosting touch pattern label film, the plurality of particles of the printing ink of the three-dimensional pattern layer have a particle size of approximately 35-45 μm.

In the above three-dimensional frosting touch pattern label film, the plurality of particles of the printing ink of the three-dimensional pattern layer are formed of methyl methacrylate resin.

The manufacturing method of a three-dimensional frosting touch pattern label film according to the present invention comprises the following steps:

(a) preparation of printing ink, in which a composition including acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10% are provided and mixed to form a printing ink containing a plurality of particles;

(b) gravure printing, in which the printing ink prepared in step (a) is loaded into a gravure printing machine to conduct a gravure printing operation for printing and combining a display pattern including at least one of a pattern, a character, and a mark on a surface of a single-layered label film substrate;

(c) formation of frosting and sanding touch three-dimensional pattern layer, in which, after the operation of printing the pattern on the surface of the single-layered label film substrate conducted in step (b), the display pattern formed on the surface of the single-layered label film substrate forms at least one three-dimensional pattern layer having a height of approximately 0.05-0.1 mm and showing three-dimensional particle frosting visual perception and sanding touch;

(d) slitting processing, in which the signal-layered label film substrate that comprises the three-dimensional pattern layer that shows three-dimensional particle frosting visual perception and sanding touch obtained in step (c) is slit and cut with a slitting machine to form a plurality of label film strips;

(e) adhering processing, in which each of the label film strips obtained through the slitting processing of step (d) is processed to have two opposite edges thereof lapping and adhered to each other; and

(f) cutting and trimming, in which the plurality of label film strips that have been completed with the adhering processing of step (e) are cut and trimmed to form a three-dimensional pattern label film having the three-dimensional pattern layer showing three-dimensional particle frosting visual perception and sanding touch.

The efficacy of the three-dimensional frosting touch pattern label film and the manufacturing method thereof according to the present invention is that the printing ink that is formed of a mixture of acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10% and contains a plurality of particles therein can securely attach, through printing, to and combine with a single-layered label film substrate and forms a three-dimensional pattern showing frosting visual perception and sanding touch, allowing for wide application on outer packaging of a liquid-holding container, including a bottle, a kettle, and a jar that is made of glass, ceramics, or plastics that are not glass nor ceramics to provide three-dimensional frosting visual perception and sanding touch similar to glass or ceramic products without the need to apply polishing or sanding operations that are time-consuming, labor-consuming, expensive, and non-mass-productive to a liquid-holding container, such as a bottle, a kettle, or a jar, made of glass and ceramics. Further, the label film that has a three-dimensional pattern showing frosting visual perception and sanding touch can be simply fit over and thermally shrunk on and wrapped around the outside of a liquid-holding container product, including a bottle, a kettle, a jar, and the likes that are made of glass, ceramics, or plastics that are not glass nor ceramics for holding various beverages to allow the outside surface of the container, such as a bottle, a kettle, a jar, or the likes, to form and possess the high-end packaging quality and feeling of a three-dimensional pattern of real glass or ceramic material that has subjected to polishing or sanding to show frosting visual perception and sanding touch and is applicable in a wide operation temperature range of a middle-high temperature range of 50-150° C. and is applicable to surfaces of all sorts of thermal shrinkage label films that are currently available in the market and made of various materials so as to provide a remarkable effect of improvement, as compared to all prior art or existing thermal shrinkage package films, to help expand an application range and industrial value of the thermal shrinkage label film products.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a three-dimensional frosting touch pattern label film according to the present invention;

FIG. 2 is a cross-sectional view of the three-dimensional frosting touch pattern label film of the present invention taken along line X-X′ of FIG. 1, showing a condition in which a three-dimensional pattern is formed on a single-layered label film substrate;

FIG. 3 is a flow chart illustrating a method for making the three-dimensional frosting touch pattern label film according to the present invention;

FIG. 4 is a schematic view illustrating a condition of the three-dimensional frosting touch pattern label film according to the present invention after gravure printing;

FIG. 5 is a schematic view illustrating slitting of the three-dimensional frosting touch pattern label film according to the present invention;

FIG. 6 is a schematic view illustrating adhering of the three-dimensional frosting touch pattern label film according to the present invention;

FIG. 7 shows a first example of application of the three-dimensional frosting touch pattern label film according to the present invention;

FIG. 8 is a schematic view illustrating a condition of fitting the three-dimensional frosting touch pattern label film of the present invention over an outside of a bottle-like object of FIG. 7; and

FIG. 9 shows a second example of application of the three-dimensional frosting touch pattern label film according to the present invention.

### DETAILED DESCRIPTION OF THE PREFERRED EMBODIMENTS

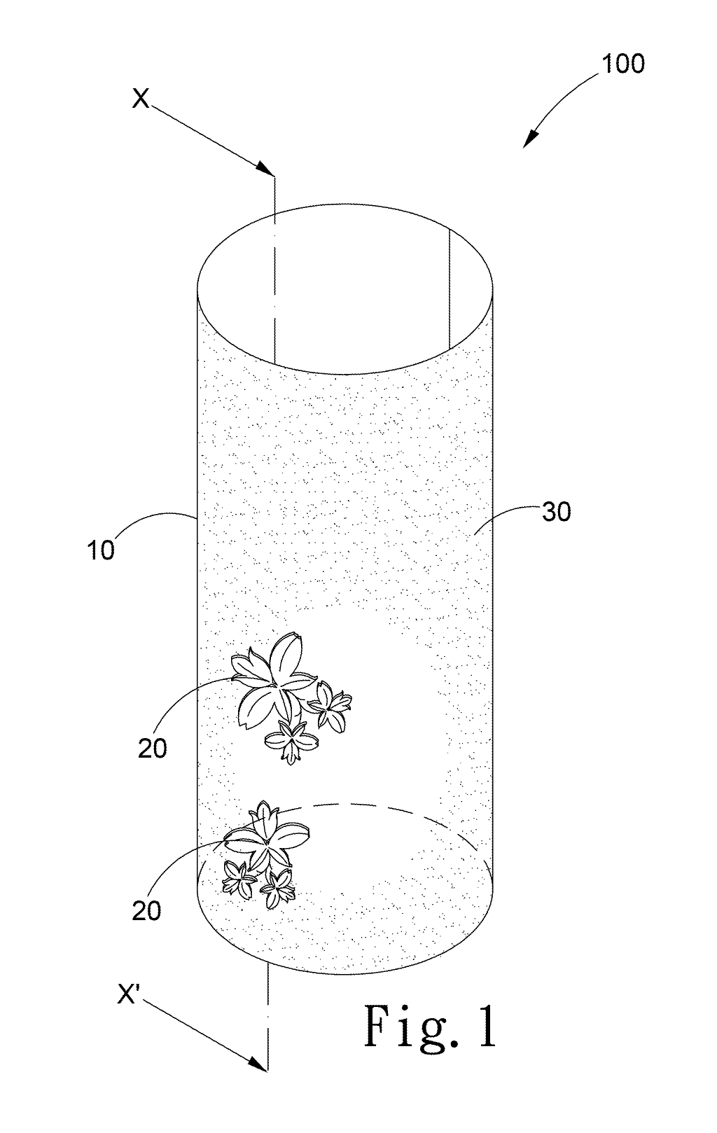

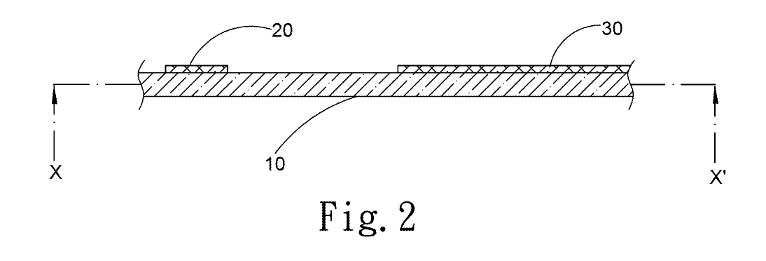

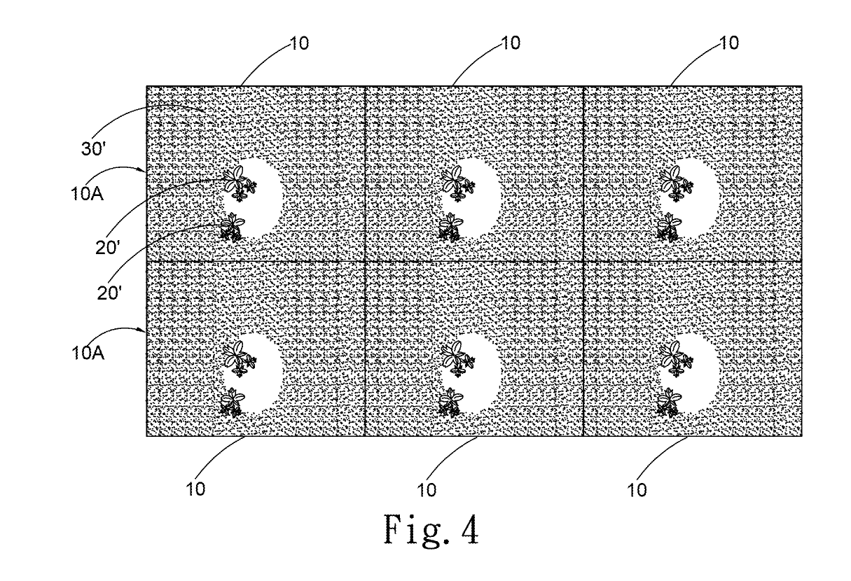

Referring to FIGS. 1 and 2, the present invention provides a three-dimensional frosting touch pattern label film 100, which comprises a single-layered label film substrate 10, wherein the single-layered label film substrate 10 can be formed of a single layer of a film material such as PVC, OPS, PET-G, PLA, BOPP, POF, CPP, or OPP, and at least a three-dimensional pattern layer 20, 30 comprises acrylic resin having a volume ratio of 20-30%, a particle-hand-feeling additive having a volume ratio of 10-20%, toluene having a volume ratio of 30-40%, isopropyl alcohol having a volume ratio of 15-25%, ethyl acetate having a volume ratio of 15-25%, and butanone having a volume ratio of 1-10%, which are mixed to form a printing ink containing a plurality of particles. The particles are formed by the particle-hand-feeling additive and have a particle size of approximately 35-45 μm. The particle-hand-feeling additive is not limited to any specific form and is formed of a material selected from for example methyl methacrylate resin. Thus, the printing ink is used to print and combine a display pattern 20′, 30′ (as shown in FIG. 4) including at least one of a pattern, a character, and a mark on a surface of the single-layered label film substrate 10 by means of gravure printing so that the display pattern 20′, 30′ printed on the surface of the single-layered label film substrate 10 with the printing ink that contains a plurality of particles forms a three-dimensional pattern layer 20, 30 (as shown in FIG. 2) having a height of 0.05-0.1 mm and providing three-dimensional frosting visual perception and sanding touch.

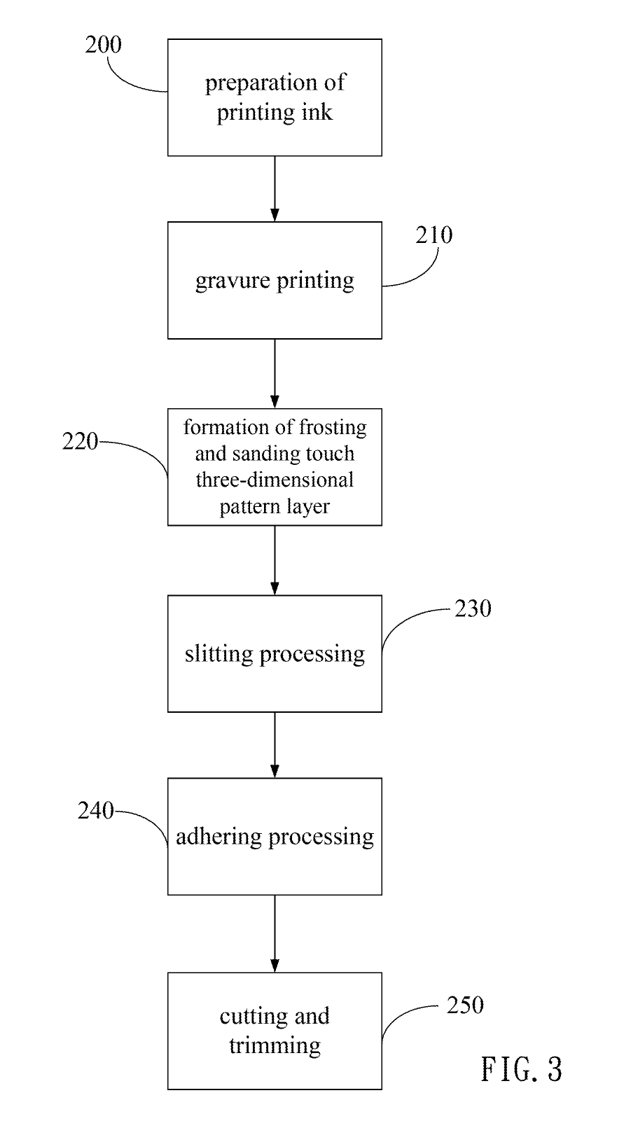

Referring also to FIG. 3, which illustrates a flow chart of a method for making a three-dimensional pattern label film according to the present invention, the method comprises Steps 200-250, which are described as follows:

Step 200, preparation of printing ink, in which a composition including acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10% are provided and mixed to form a printing ink containing a plurality of particles;

Step 210, gravure printing, in which, as shown in FIG. 4, the printing ink prepared in Step 200 is loaded into a gravure printing machine to conduct a gravure printing operation for printing and combining a display pattern 20′, 30′ including at least one of a pattern, a character, and a mark on a surface of a single-layered label film substrate 10;

Step 220, formation of frosting and sanding touch three-dimensional pattern layer, in which, after the operation of printing the pattern on the surface of the single-layered label film substrate 10 conducted in Step 210, the display pattern 20′, 30′ formed on the surface of the single-layered label film substrate 10 forms at least one three-dimensional pattern layer 20, 30 having a height of approximately 0.05-0.1 mm and showing three-dimensional particle frosting visual perception and sanding touch;

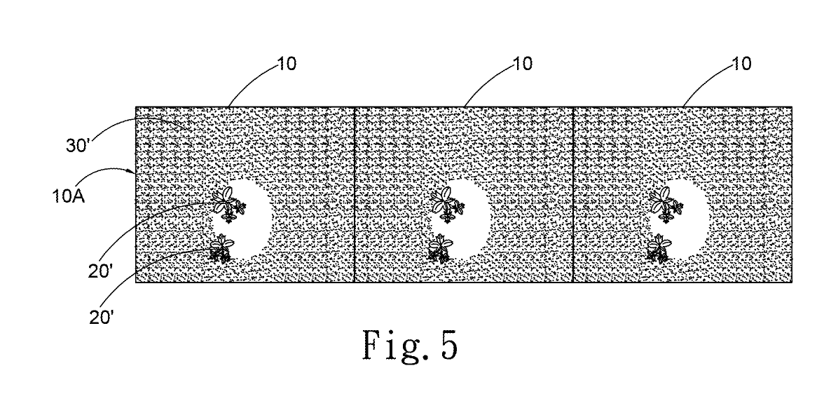

Step 230, slitting processing, in which, as shown in FIG. 5, the signal-layered label film substrate 10 that comprises at least one three-dimensional pattern layer 20, 30 showing three-dimensional particle frosting visual perception and sanding touch obtained in Step 220 is slit and cut with a slitting machine to form a plurality of label film strips 10A;

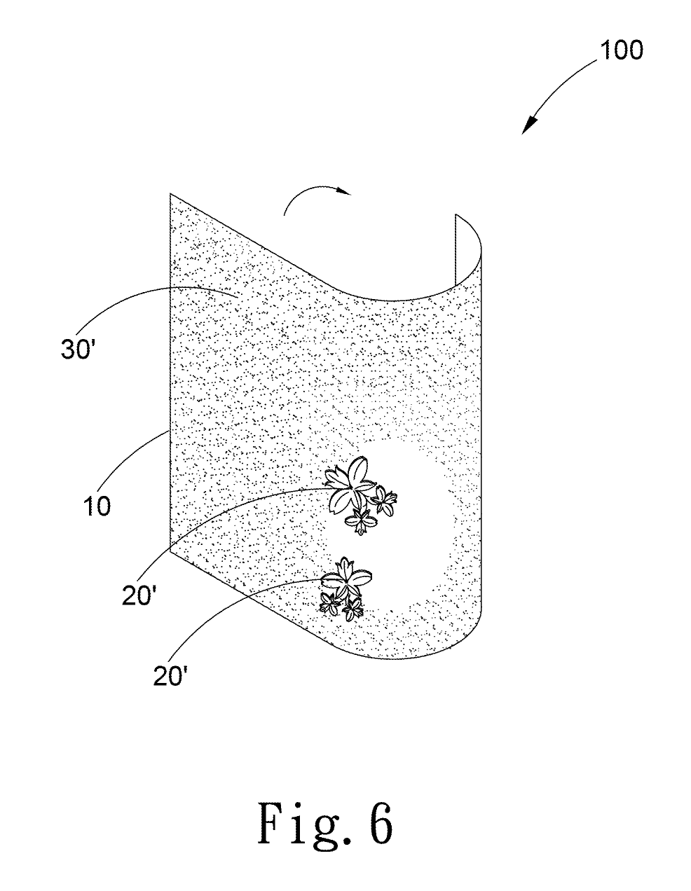

Step 240, adhering processing, in which, as shown in FIG. 6, each of the label film strips 10A obtained through the slitting processing of Step 230 is processed to have two opposite edges thereof lapping and adhered to each other (as indicated by the arrow of FIG. 6); and

Step 250, cutting and trimming, in which the plurality of label film strips 10A that have been completed with the adhering processing of Step 240 are cut and trimmed to form the three-dimensional pattern label film 100 having the three-dimensional pattern layer 20, 30 as shown in FIG. 1.

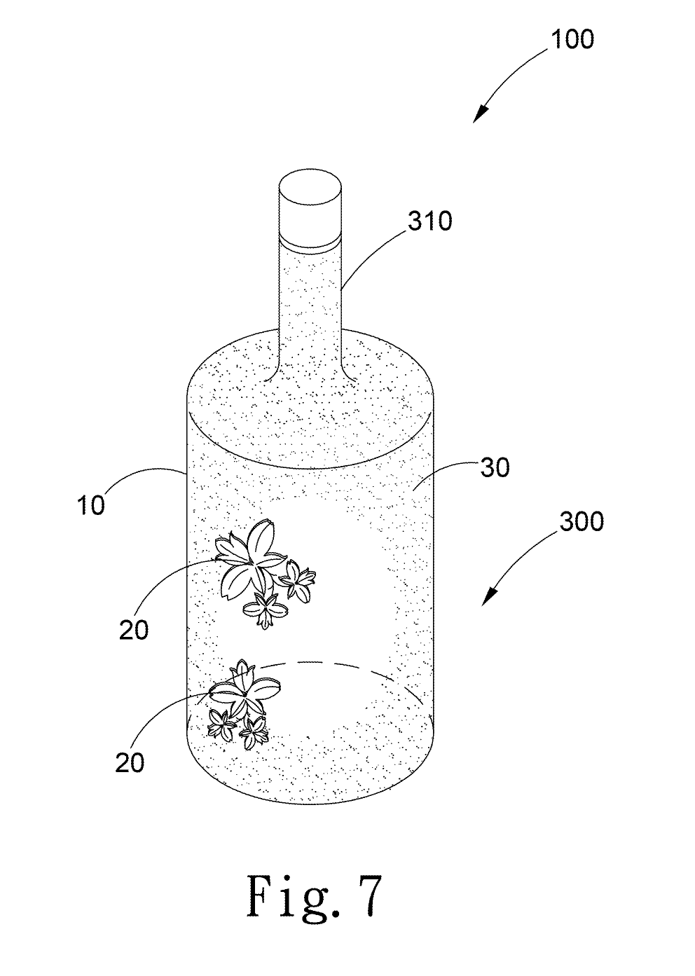

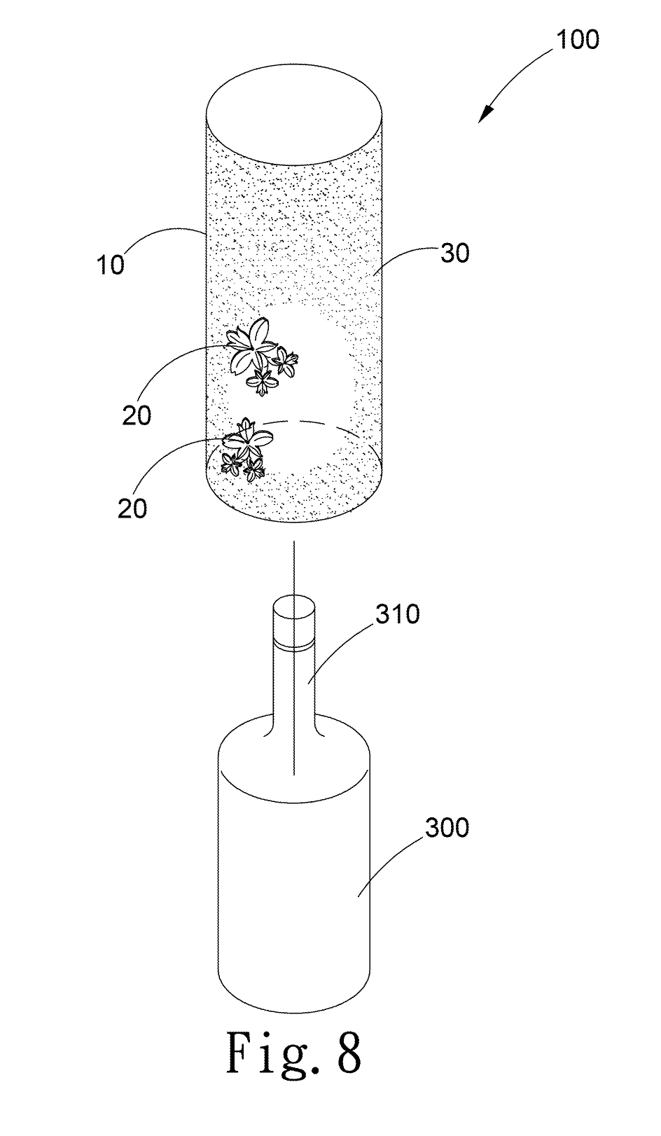

Referring further to FIGS. 7 and 8, a first example of application of the three-dimensional pattern label film 100 of the present invention is illustrated, where the three-dimensional pattern label film 100 is fit over a bottle-like object 300 and is heated by a hot-stream thermal shrinkage machine or steam-based thermal shrinkage machine having a wide operation temperature range that is a high temperature range of 90-150° C. or a middle-high temperature range of 50-150° C. so that the three-dimensional pattern label film 100 is thermally shrunk on and thus wrapped around a surface of the bottle-like object 300 to provide the surface of the bottle-like object 300 with the three-dimensional pattern layer 20, 30 that shows three-dimensional frosting visual perception and sanding touch. Particularly, the three-dimensional frosting visual perception and sanding touch are made more significant and more noticeable at portions having small diameters or high shrinkage rates, or slender curved portions. For example, the three-dimensional frosting visual perception and sanding touch of the three-dimensional pattern layer 30 are more significant and more noticeable at locations near a neck 310 of the bottle-like object 300. Particularly, in addition to formation by means of the particle-hand-feeling additive, the three-dimensional pattern layer 20, 30 of the present invention can demonstrate distinctiveness through selection and application of various angles, depths, and dot shapes of gravure printing.

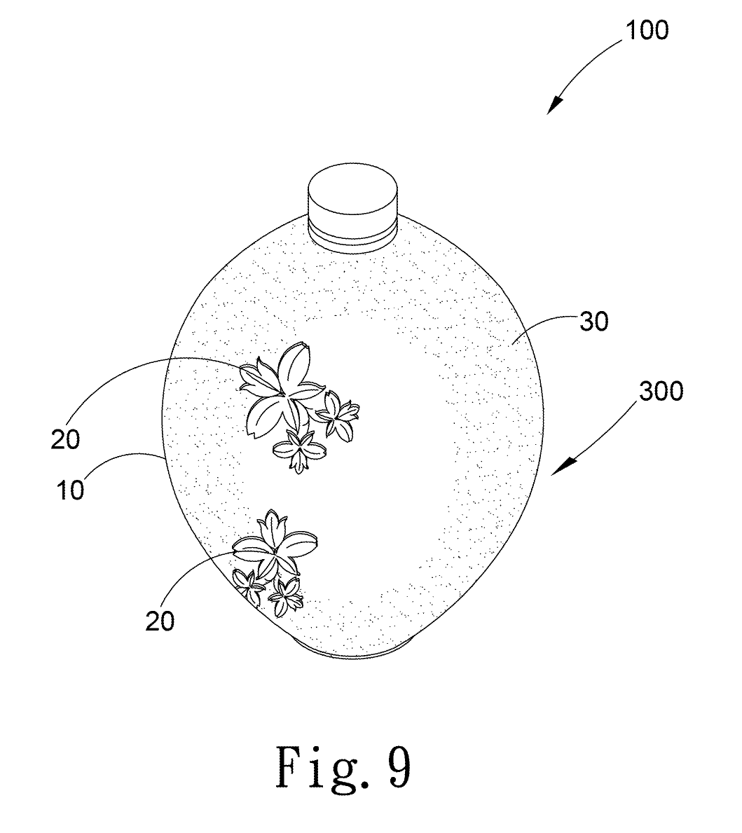

Referring to FIG. 9, a second example of application of the three-dimensional pattern label film 100 of the present invention is illustrated, where the three-dimensional pattern label film 100 is thermally shrunk on and wrapped around an outside of a jar-like object 300, the three-dimensional pattern layer 40, 50 on the surface of the single-layered label film substrate 10 shows three-dimensional visual perception and sanding touch so that surface of the jar-like object 400 exhibits high-quality decoration presented as antique-mimicking polishing or sanding, being useable to replace or remedy monotonous outside decoration and/or poor quality appearance of an ordinary jar-like object 400 that is used to contain and hold liquor and alcohol for the purposes of upgrading package quality, product quality, and touch feeling of a liquid-holding container, such as a bottle-like object 300, the jar-like object 400, or a kettle-like object (not shown) and offering an effect of environmental conservation.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A three-dimensional frosting touch pattern label film, comprising:
a single-layered label film substrate; and
at least a three-dimensional pattern layer, which comprises acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10%, which are mixed to form a printing ink containing a plurality of particles, and subjected to a step of gravure printing to have a display pattern comprising at least one of a pattern, a character, and a mark printed on and combined with a surface of the single-layered label film substrate such that the display pattern on the surface of the single-layered label film substrate forms at least one three-dimensional pattern layer having a height of 0.05-0.1 mm and providing three-dimensional particle frosting visual perception and sanding touch.

2. The three-dimensional frosting touch pattern label film as claimed in claim 1, wherein the single-layered label film substrate is formed of a single layer of a film material comprising one of PVC, OPS, PET-G, PLA, BOPP, POF, CPP, and OPP.

3. The three-dimensional frosting touch pattern label film as claimed in claim 1, wherein the particle-hand-feeling additive of the printing ink that comprises the plurality of three-dimensional particles in the three-dimensional pattern layer is formed of a material comprising methyl methacrylate resin.

4. The three-dimensional frosting touch pattern label film as claimed in claim 1, wherein the plurality of particles of the printing ink of the three-dimensional pattern layer have a particle size of approximately 35-45 μm.

5. The three-dimensional frosting touch pattern label film as claimed in claim 1, wherein the plurality of particles of the printing ink of the three-dimensional pattern layer are formed of methyl methacrylate resin.

6. A method for making a three-dimensional frosting touch pattern label film, comprising the following steps:
(a) preparation of printing ink, in which a composition including acrylic resin of a volume ratio of 20-30%, a particle-hand-feeling additive of a volume ratio of 10-20%, toluene of a volume ratio of 30-40%, isopropyl alcohol of a volume ratio of 15-25%, ethyl acetate of a volume ratio of 15-25%, and butanone of a volume ratio of 1-10% are provided and mixed to form a printing ink containing a plurality of particles;
(b) gravure printing, in which the printing ink prepared in step (a) is loaded into a gravure printing machine to conduct a gravure printing operation for printing and combining a display pattern including at least one of a pattern, a character, and a mark on a surface of a single-layered label film substrate;
(c) formation of frosting and sanding touch three-dimensional pattern layer, in which, after the operation of printing the pattern on the surface of the single-layered label film substrate conducted in step (b), the display pattern formed on the surface of the single-layered label film substrate forms at least one three-dimensional pattern layer having a height of approximately 0.05-0.1 mm and showing three-dimensional particle frosting visual perception and sanding touch;
(d) slitting processing, in which the signal-layered label film substrate that comprises the three-dimensional pattern layer that shows three-dimensional particle frosting visual perception and sanding touch obtained in step (c) is slit and cut with a slitting machine to form a plurality of label film strips;
(e) adhering processing, in which each of the label film strips obtained through the slitting processing of step (d) is processed to have two opposite edges thereof lapping and adhered to each other; and
(f) cutting and trimming, in which the plurality of label film strips that have been completed with the adhering processing of step (e) are cut and trimmed to form a three-dimensional pattern label film having the three-dimensional pattern layer showing three-dimensional particle frosting visual perception and sanding touch.

7. The method for making the three-dimensional frosting touch pattern label film as claimed in claim 6, wherein the particle-hand-feeling additive of the printing ink that comprises the plurality of three-dimensional particles in the three-dimensional pattern layer of step (a) is formed of a material comprising methyl methacrylate resin.

8. The method for making the three-dimensional frosting touch pattern label film as claimed in claim 6, wherein the single-layered label film substrate of step (b) is formed of a single layer of a film material comprising one of PVC, OPS, PET-G, PLA, BOPP, POF, CPP, and OPP.

9. The method for making the three-dimensional frosting touch pattern label film as claimed in claim 6, wherein the plurality of particles of the printing ink of the three-dimensional pattern layer of step (c) have a particle size of approximately 35-45 μm.

10. The method for making the three-dimensional frosting touch pattern label film as claimed in claim 6, wherein the plurality of particles of the printing ink of the three-dimensional pattern layer of step (c) are formed of methyl methacrylate resin.
